(19) United States
(12) Patent Application Publication
(10) Pub. No.: US 2020/0321786 A1
(43) Pub. Date: Oct. 8, 2020

(54) Battery Charging Control Method and Apparatus, and Electric Vehicle

(71) Applicant: Guangzhou Automobile Group Co., Ltd., Guangzhou (CN)

(72) Inventors: Jiucai ZHANG, Sunnyvale, CA (US); Ao MEI, Guangzhou (CN); Jun WANG, Guangzhou (CN); Zhi LI, Guangzhou (CN); Chao LIU, Guangzhou (CN); Sichao GUO, Guangzhou (CN)

(21) Appl. No.: 16/377,271

(22) Filed: Apr. 8, 2019

(51) Int. Cl. H02J 7/00; B60L 50/64; B60L 58/22

(52) U.S. Cl. CPC H02J 7/0014; B60L 50/64; B60Y 2400/112; B60Y 2200/91; B60L 58/22

(57) ABSTRACT

Disclosed are a battery charging control method and apparatus, and a battery powered device such as an electric vehicle. The method, for each cell in at least one cell of a multi-cell battery, includes: after the multi-cell battery enters a charging stable state, acquiring actual charging electric quantity required for charging the cell to a target voltage; determining a balance time duration for the cell based on the actual charging electric quantity corresponding to the cell, wherein the balance time duration is a time duration required for a cell balance control circuit matched with the cell to control the cell; and controlling the cell balance control circuit matched with the cell to perform electric quantity adjustment on the cell within the balance time duration. The technical problem of low accuracy of balance control on each cell in the multi-cell battery in the related art is solved.

### TECHNICAL FIELD

The disclosure relates to the field of electronics, and more particularly, to a battery charging control method and apparatus, and an electric vehicle.

### BACKGROUND

In a process when a multi-cell battery composed of multi-cell batteries is applied to a random dynamic working condition of a vehicle, due to its differences in a production process, a service environment, self-discharge, and the like, the performance of each cell is often inconsistent and thus the problems of overcharge, over-discharge and inaccurate state performance prediction of the multi-cell battery are caused.

At present, a control manner provided in the related art implements balance control on each cell battery in the multi-cell battery using a result of indirect estimation such as a voltage derived capacity difference or state of charger difference at cell level. However, for a complex working condition frequently and randomly occurred in a vehicle driving process, if the above indirect estimation method is stilled adopted, the accuracy of the balance control on the performance of each cell battery cannot be guaranteed.

For the above problems, there hasn't any effective solution yet till now.

### SUMMARY

The embodiments of the disclosure provide a battery charging control method and apparatus, and a battery powered device such as an electric vehicle, so as to at least solve the technical problem of low accuracy of balance control on each cell battery in a multi-cell battery.

According to one aspect of the embodiments of the disclosure, there is provided a battery charging control method, for each cell in at least one cell of a multi-cell battery, which includes: after the multi-cell battery enters a charging stable state, actual charging electric quantity required for charging the cell to a target voltage is acquired; a balance time duration for the cell is determined based on the actual charging electric quantity corresponding to the cell, wherein the balance time duration is a time duration required for a cell balance control circuit matched with the cell to control the cell: and the cell balance control circuit matched with the cell is controlled to perform electric quantity adjustment on the cell within the balance time duration.

According to another aspect of the embodiments of the disclosure, there is provided a battery charging control apparatus, for each cell in at least one cell of a multi-cell battery, which includes: a processor, configured to execute a computer executable instruction; and a memory, configured to store the computer executable instruction; and the computer executable instruction, when being executed by the processor, enables the apparatus to execute the following steps: after the multi-cell battery enters a charging stable state, actual charging electric quantity required for charging the cell to a target voltage is acquired; a balance time duration for the cell is determined based on the actual charging electric quantity corresponding to the cell, wherein the balance time duration is a time duration required for a cell balance control circuit matched with the cell to control the cell; and the cell balance control circuit matched with the cell is controlled to perform electric quantity adjustment on the cell within the balance time duration.

According to still another aspect of the embodiments of the disclosure, there is provided an electric vehicle, for each cell in at least one cell of a multi-cell battery, which includes: a processor, configured to execute a computer executable instruction; and a memory, configured to store the computer executable instruction; and the computer executable instruction, when being executed by the processor, enables the electric vehicle to execute the following steps: after the multi-cell battery enters a charging stable state, actual charging electric quantity required for charging the cell is charged to a target voltage is acquired; a balance time duration for the cell is determined based on the actual charging electric quantity corresponding to the cell, wherein the balance time duration is a time duration required for a cell balance control circuit matched with the cell to control the cell; and the cell balance control circuit matched with the cell is controlled to perform electric quantity adjustment on the cell within the balance time duration.

In the embodiments of the disclosure, after the multi-cell battery enters the charging stable state, the actual charging electric quantity required for charging each cell to the target voltage is acquired, the balance time duration for the cell is determined according to the actual charging electric quantity, and the cell is controlled to perform the electric quantity adjustment according to the balance time duration. In the above method, since the actual charging electric quantity required for charging the each cell to the target voltage is acquired, the electric quantity adjustment may be performed on the cell according to the balance time duration acquired by the actual charging electric quantity, and the purpose of adjusting the each cell accurately is achieved. Therefore, the technical problem of low accuracy of balance control on each cell in the multi-cell battery in the related art is solved.

### BRIEF DESCRIPTION OF THE DRAWINGS

The accompanying drawings are described here to provide a further understanding of the disclosure and form a part of the disclosure. The schematic embodiments and description of the disclosure are adopted to explain the disclosure, and do not form improper limits to the disclosure. In the drawings:

FIG. 1 is a flowchart diagram of an optional battery charging control method according to an embodiment of the disclosure;

FIG. 2 is a schematic diagram of an optional battery charging control method according to an embodiment of the disclosure;

FIG. 3 is a schematic diagram of another optional battery charging control method according to an embodiment of the disclosure;

FIG. 4 is a schematic diagram of a still another optional battery charging control method according to an embodiment of the disclosure;

FIG. 5 is a schematic diagram of a still another optional battery charging control method according to an embodiment of the disclosure;

FIG. 6 is a structural schematic diagram of an optional battery charging control apparatus according to an embodiment of the disclosure; and

FIG. 7 is a structural schematic diagram of an electric vehicle according to an embodiment of the disclosure.

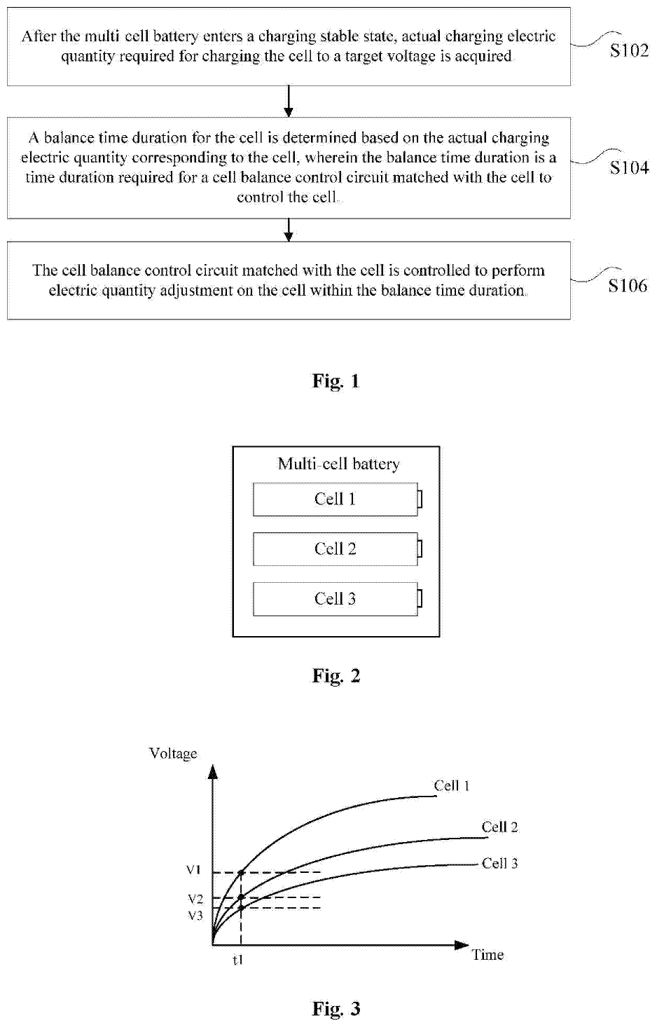

### DETAILED DESCRIPTION OF THE EMBODIMENTS

In order to make those skilled in the art better understand the solutions of the disclosure, the technical solutions in the embodiments of the disclosure will be clearly and completely described herein below with reference to the drawings in the embodiments of the disclosure. It is apparent that the described embodiments are only a part of the embodiments of the disclosure, not all of the embodiments. On the basis of the embodiments of the disclosure, all other embodiments obtained on the premise of no creative work of those of ordinary skill in the art shall fall within the scope of protection of the disclosure.

It is to be noted that the specification and claims of the disclosure and terms “first”, “second” and the like in the drawings are intended to distinguish similar objects, and do not need to describe a specific sequence or a precedence order. It should be understood that data used in such a way may be exchanged under appropriate conditions, in order that the embodiments of the disclosure described here can be implemented in a sequence except sequences graphically shown or described here. In addition, terms “comprise”, “include” and variations thereof are intended to cover non-exclusive inclusions. For example, processes, methods, systems, products or devices containing a series of steps or units do not need to clearly show those steps or units, and may include other inherent steps or units of these processes, methods, products or devices, which are not clearly shown.

According to one aspect of the embodiments of the disclosure, there is provided a battery charging control method. Optionally, as an optional implementation manner, the, battery charging control method, for each cell in at least one cell of a multi-cell battery, includes the following steps.

At S102, after the multi-cell battery enters a charging stable state, actual charging electric quantity required for charging the cell to a target voltage is acquired.

At S104: a balance time duration for the cell is determined based on the actual charging electric quantity corresponding to the cell, wherein the balance time duration is a time duration required for a cell balance control circuit matched with the cell to control the cell.

At S106: the cell balance control circuit matched with the cell is controlled to perform electric quantity adjustment on the cell within the balance time duration.

Optionally, the battery charging control method may be applied, but not limited, to a process when the cells in the multi-cell battery are controlled to charge. For example, with the process when the cells in the multi-cell battery mounted on an electric vehicle are controlled to charge as an example, in the process of charging the multi-cell battery on the electric vehicle, after the multi-cell battery enters a charging stable state, an actual charging electric quantity required for charging each cell to a target voltage is acquired, a balance time duration for the cell is determined according to the actual charging electric quantity, and electric quantity adjustment is performed on the cell based on cell balance control circuit according to the balance time duration.

It is to be noted that, each cell is often balanced based on a result indirectly estimated according to a voltage difference among the cells in the process of charging the multi-cell battery in the related art. However, the above method cannot guarantee the, accuracy of the balance control on the performance of each cell. In this embodiment, since the actual charging electric quantity required for charging the each cell to the target voltage is acquired, the electric quantity adjustment may be performed on the cell according to the balance time duration acquired by the actual charging electric quantity, and the purpose of adjusting the each cell accurately is achieved.

Optionally, as an optional implementation manner, before the actual charging electric quantity required for charging the cell to the target voltage is acquired, the method further includes the following steps.

At S1: accumulated charging electric quantity since the multi-cell battery enters a charging state is acquired.

At S2, the multi-cell battery is determined to enter the charging stable state under a condition in which the accumulated charging electric quantity reaches a first threshold.

For example, the above is described with reference to FIG. 2. For instance, the multi-cell battery includes three cells. After the multi-cell battery starts to charge, each cell corresponds to one accumulated charging electric quantity. As shown in FIG. 3, It may be seen that on the condition that the accumulated charging electric quantity of the multi-cell battery reaches a first threshold, all cells enter the stable states at t1. The highest voltage (that is V1) at t1 is set as the target voltage. As the multi-cell battery is charged safer t1 the actual capacity of each cell to the target voltage is tracked.

Optionally, following that the accumulated charging electric quantity since the multi-cell battery enters the charging state is acquired, the method further includes the following step.

At S1, the accumulated charging electric quantity is cleared under a condition in which the accumulated charging electric quantity does not reach the first threshold and the charging is terminated.

For instance, the above is described continuously with reference to the above condition in which the multi-cell battery includes the cell 1, the cell 2 and the cell 3. With reference to FIG. 3, by taking the cell 1 as an example, the cell 1 reaches the charging stable state after being charged for t1. However, in a case where the charging is terminated under a condition in which the charging time is not up to the t1, then the cell 1 does not reach the charging stable state, and the accumulated charging electric quantity needs to be cleared. Thus, in a next time of charging, the accumulated charging electric quantity of the cell 1 is re-measured. In this way, the problem of inaccuracy of the accumulated charging electric quantity acquired under the, condition that charging is terminated and then continued can be prevented.

Optionally, the step that the actual charging electric quantity required for charging a cell included in the multi-cell battery to the target voltage is acquired includes the following acts.

At S1, cell stabilized voltages that a plurality of cells comprised in the multi-cell battery reaches respectively when entering the charging stable state are acquired.

At S2, the target voltage is determined according to the cell stabilized voltages.

Optionally, the act that the target voltage is determined according to the cell stabilized voltages may refer, but not limited, to determine a maximum cell stabilized voltage in the cell stabilized voltages of the cells in the multi-cell battery as the target voltage.

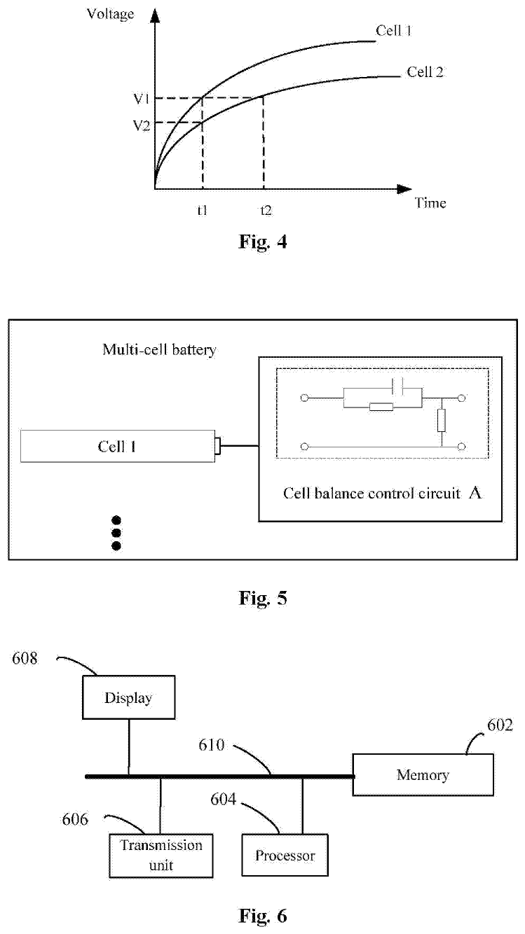

For instance, the above is described continuously with reference to the above condition in which the multi-cell battery includes three cells and in conjunction with the cell 1 and the cell 2. As shown in FIG. 4, it is a diagram in which voltages of optional cell 1 and cell 2 are changed with a time. At the moment t1, the cell 1 and the cell 2 both reach the charging stable state. At this moment, the cell stabilized voltage of the cell 1 is V1 and that of the, cell 2 is V2. In a case where V1 is determined as the target voltage, V2 needs to be adjusted. In the process when V2 is adjusted to V1, the time is changed from the t1 into the t2. At this point, the actual charging electric quantity of the cell 2 in the process from the t1 to the t2 is calculated. Thus, the actual capacity of a tracked cell (that is cell 2) to the target voltage is the capacity difference between the tracked cell and the cell with the highest voltage.

It is should be noted that to align all cells' capacities to the cell with the highest capacity, the actual balanced capacity is the subtraction of actual capacity of each cell to the target voltage with the maximum of the actual capacities of all cells.

For example, the balanced capacity of each cell should be the difference between the, average actual capacity of all cells and actual capacity of each cell. In this whole process, the current should be stable, which means that the current variation should be within a given threshold, such as 2 A, depending on the value of the cell internal resistance. If the current variation is beyond the given threshold, the whole process has to start from the beginning and all accumulated capacities are reset to zeros.

Through the above method, the accuracy of acquiring the actual charging electric quantities and the acquisition efficiency are improved.

Optionally, in the process of acquiring the actual charging electric quantity required for charging the cell to the target voltage, the method further includes the following steps.

At S1, a cell temperature in an environment where the cell is located at present is acquired.

At S2, temperature compensation is performed on the actual charging electric quantity corresponding to the cell according to a temperature curve. Herein, under a condition in which the cell temperature in the environment where the cell is located at present is greater than a target temperature, the actual charging electric quantity is turned down according to a first proportion indicated by the temperature curve; and under a condition in which the cell temperature in the environment where the cell is located at present is smaller than the target temperature, the actual charging electric quantity is turned up according to a second proportion indicated by the temperature curve.

For instance, the above is described with reference to the condition in which the multi-cell battery includes three cells and by taking the cell 1 as an example. Since the temperature has an impact on the actual charging electric quantities of the cells, the cell temperature of the current environment further needs to be acquired in the process of calculating the actual charging electric quantities. For example, the target temperature is indicated by b and the corresponding compensation proportion is r1. In a case where the cell temperature is c (c>b), the temperature compensation needs to be performed on the actual charging electric quantities using the compensation proportion r1 corresponding to the cell temperature c. In a case where the cell temperature is a(a<b), the temperature compensation needs to be performed on the actual charging electric quantities using the compensation proportion r2 corresponding to the cell temperature a. Wherein, the compensation proportion r1 may equal to the compensation proportion r2, and the compensation proportion r1 may be different from the compensation proportion r2, which is determined by the temperature curve.

Therefore, the influence of different cell temperatures on a balance process of the multi-cell battery charging is prevented and the balance efficiency of balancing the multi-cell battery is improved.

Optionally, the step that a balance time duration for the cell is determined based on the actual charging electric quantity corresponding to the cell includes the following acts.

At S1, unit balance electric quantity configured to the cell balance control circuit to match with the cell is acquired.

At S2, a ratio of the actual charging electric quantity to the unit balance electric quantity is acquired, and the balance time duration corresponding to the cell equal to the ratio is set.

For instance, the above is described continuously with reference to the above condition in which the multi-cell battery includes the cell 1, the cell 2 and the cell 3. With reference to FIG. 5, by taking the cell 1 as an example, a cell balance control circuit A is provided for controlling the cell 1 of the multi-cell battery, wherein each cell balance control circuit is provided with a unit balance electric quantity. After the actual charging electric quantity of the cell 1 is acquired, the balance time duration is acquired using the following formula:

balance time duration=actual charging electric quantity/unit balance electric quantity.

Through the above formula, the balance time duration may be acquired accurately and efficiently, and the efficiency of acquiring the balance time duration is improved.

Optionally, the step that the cell balance control circuit matched with the cell is controlled to perform electric quantity adjustment on the cell within the balance time duration includes the following acts.

At S1, the cell balance control circuit matched with the cell is controlled to stop the electric quantity adjustment on the cell under a condition in which an end moment of the balance time duration is reached and the multi-cell battery is balanced.

At S2, updated actual charging electric quantity corresponding to the cell is acquired under a condition in which the end moment of the balance time duration is reached while the multi-cell battery is not balanced; an updated balance time duration is determined based on the updated actual charging electric quantity; and the cell balance control circuit matched with the cell is controlled to perform the electric quantity adjustment on the cell within the updated balance time duration.

For instance, the above is described continuously with reference to the above condition in which the multi-cell battery includes three cells. In a case where the multi-cell battery still is not balanced after the cell balance control circuits are used to balance the cell 1, the cell 2 and the cell 3 respectively within the balance time duration, updated actual charging electric quantities need to be acquired; and then, balance time durations are determined according to new actual charging electric quantities and the cell 1, the cell 2 and the cell 3 are balanced. In a case where the multi-cell battery is up to a balance state prior to the balance time duration in the process of balancing the cell 1, the cell 2 and the cell 3 with the cell balance control circuits, the balance on the multi-cell battery is stopped. In this way, the balance on the multi-cell battery, may be stopped timely.

It is to be noted that, to make the description brief, the foregoing method embodiments are expressed as a series of actions. However, a person skilled in the art should appreciate that the disclosure is not limited to the described action sequence, because according to the disclosure, some steps may be performed in other sequences or performed simultaneously. In addition, a person skilled in the art should also appreciate that all the embodiments described in the specification are preferred embodiments, and the related actions and modules are not necessarily limited to the disclosure.

According to another aspect of the embodiments of the disclosure, there is further provided a battery charging control apparatus for implementing the above battery charging control method. As shown in FIG. 6, the apparatus, for each cell in at least one cell of a multi-cell battery, includes a processor 604 and a memory 602.

(1) The processor 604 is configured to execute a computer executable instruction.

(2) The memory 602 is configured to store the computer executable instruction; and the computer executable instruction, when being executed by the processor, enables the apparatus to execute the following steps.

At S1, after the multi-cell battery enters a charging stable state, actual charging electric quantity required for charging the cell to a target voltage is acquired.

At S2: a balance time duration for the cell is determined based on the actual charging electric quantity corresponding to the cell, wherein the balance time duration is a time duration required for a cell balance control circuit matched with the cell to control the cell.

At S3: the cell balance control circuit matched with the cell is controlled to perform electric quantity adjustment on the cell within the balance time duration.

Optionally, the battery charging control apparatus may further includes but not limited to a transmission unit 606, a display unit 608 and a connection bus 610.

(3) The transmission unit 606 is configured to receive or send data via a network.

(4) The display unit 608 is configured to display a balance state of the multi-cell battery.

(5) The connection bus 610 is configured to connect each modular component in the battery charging control apparatus.

It is to be noted that, each cell is often balanced based on a result indirectly estimated according to a voltage difference among the cells in the process of charging the, multi-cell battery in the related art. However, the above method cannot guarantee the accuracy of the balance control on the performance of each cell. In this embodiment, since the actual charging electric quantity required for charging the each cell to the target voltage is acquired, the electric quantity adjustment may be performed on the cell according to the balance time duration acquired by the actual charging electric quantity, and the purpose of adjusting the each cell accurately is achieved.

Optionally, as an optional implementation manner, before the actual charging electric quantity required for charging the cell to the target voltage is acquired, the method further includes the following steps.

At S1: accumulated charging electric quantity since the multi-cell battery enters a charging state is acquired.

At S2, the multi-cell battery is determined to enter the charging stable state under a condition in which the accumulated charging electric quantity reaches a first threshold.

For example, the above is described with reference to FIG. 2. For instance, the multi-cell battery includes three cells. After the multi-cell battery starts to charge, each cell corresponds to one accumulated charging electric quantity. As shown in FIG. 3, It may be seen that on the condition that the accumulated charging electric quantity of the multi-cell battery reaches a first threshold, all cells enter the stable states at t1. The highest voltage (that is V1) at t1 is set as the target voltage. As the multi-cell battery is charged after t1, the actual capacity of each cell to the target voltage is tracked.

Optionally, following that the accumulated charging electric quantity since the multi-cell battery enters the charging state is acquired, the method further includes the following step.

At S1, the accumulated charging electric quantity is cleared under a condition in which the accumulated charging electric quantity does not reach the first threshold and the charging is terminated.

For instance, the above is described continuously with reference to the above condition in which the multi-cell battery includes the cell 1, the cell 2 and the cell 3. With reference to FIG. 3, by taking the cell 1 as an example, the cell 1 reaches the charging stable state after being charged for t1. However, in a case where the charging is terminated under a condition in which the charging time is not up to the t1, then the cell 1 does not reach the charging stable state, and the accumulated charging electric quantity needs to be cleared. Thus, in a next time of charging, the accumulated charging electric quantity of the cell 1 is re-measured. In this way, the problem of inaccuracy of the accumulated charging electric quantity acquired under the condition that charging is terminated and then continued can be prevented.

Optionally, the step that the actual charging electric quantity required for charging a cell included in the multi-cell battery to the target voltage is acquired includes the following acts.

At S1, cell stabilized voltages that a plurality of cells comprised in the multi-cell battery reaches respectively when entering the charging stable state are acquired,

At S2, the target voltage is determined according to the cell stabilized voltages.

Optionally, the act that the target voltage is determined according to the cell stabilized voltages may refer, but not limited, to determine a maximum cell stabilized voltage in the cell stabilized voltages of the cells in the multi-cell battery as the target voltage.

For instance, the above is described continuously with reference to the above condition in which the multi-cell battery includes three cells and in conjunction with the cell 1 and the cell 2. As shown in FIG. 4, it is a diagram in which voltages of optional cell 1 and cell 2 are changed with a time. At the moment t1, the cell 1 and the cell 2 both reach the charging stable state. At this moment, the cell stabilized voltage of the cell 1 is V1 and that, of the cell 2 is V2. In a case where V1 is determined as the target voltage, V2 needs to be adjusted. In the process when V2 is adjusted to V1, the time is changed from the t1 into the t2. At this point, the actual charging electric quantity of the cell 2 in the process from the t1 to the t2 is calculated. Thus, the actual capacity of a tracked cell (that is cell 2) to the target voltage is the capacity difference between the tracked cell and the cell with the highest voltage.

It is should be noted that to align all cells' capacities to the cell with the highest capacity, the actual balanced capacity is the subtraction of actual capacity of each cell to the target voltage with the maximum of the actual capacities of all cells.

For example, the balanced capacity of each cell should be the difference between the, average actual capacity of all cells and actual capacity of each cell. In this whole process, the current should be stable, which means that the current variation should be within a given threshold, such as 2 A, depending on the value of the cell internal resistance. If the current variation is beyond the given threshold, the whole process has to start from the beginning and all accumulated capacities are reset to zeros.

Through the above method, the accuracy of acquiring the actual charging electric quantities and the acquisition efficiency are improved.

Optionally, in the process of acquiring the actual charging electric quantity required for charging the cell to the target voltage, the method further includes the following steps.

At S1, a cell temperature in an environment where the cell is located at present is acquired.

At S2, temperature compensation is performed on the actual charging electric quantity corresponding to the cell according to a temperature curve. Herein, under a condition in which the cell temperature in the environment where the cell is located at present is greater than a target temperature, the actual charging electric quantity is turned down according to a first proportion indicated by the temperature curve; and under a condition in which the cell temperature in the environment where the cell is located at present is smaller than the target temperature, the actual charging electric quantity is turned up according to a second proportion indicated by the temperature curve.

For instance, the above is described with reference to the condition in which the multi-cell battery includes three cells and by taking the cell 1 as an example. Since the temperature has an impact on the actual charging electric quantities of the cells, the cell temperature of the current environment further needs to be acquired in the process of calculating the actual charging electric quantities. For example, the target temperature is indicated by b and the corresponding compensation proportion is r1. In a case where the cell temperature is c (c>b), the temperature compensation needs to be performed on the actual charging electric quantities using the compensation proportion r1 corresponding to the cell battery temperature c. In a case where the cell battery temperature is a(a<b), the temperature compensation needs to be performed on the actual charging electric quantities using the compensation proportion r2 corresponding to the cell temperature a. Wherein, the compensation proportion r1 may equal to the compensation proportion r2, and the compensation proportion r1 may be different from the compensation proportion r2, which is determined by the temperature curve.

Therefore, the influence of different cell temperatures on a balance process of the multi-cell battery charging is prevented and the balance efficiency of balancing the multi-cell battery is improved.

Optionally, the step that a balance time duration for the cell is determined based on the actual charging electric quantity corresponding to the cell includes the following acts.

At S1, unit balance electric quantity configured to the cell balance control circuit to match with the cell is acquired.

At S2, a ratio of the actual charging electric quantity to the unit balance electric quantity is acquired, and the balance time duration corresponding to the cell equal to the ratio is set.

For instance, the above is described continuously with reference to the above condition in which the multi-cell battery includes the cell 1, the cell 2 and the cell 3. With reference to FIG. 5, by taking the cell 1 as an example, a cell balance control circuit A is provided for controlling the cell 1 of the multi-cell battery, wherein each cell balance control circuit is provided with a unit balance electric quantity. After the actual charging electric quantity of the cell 1 is acquired, the balance time duration is acquired using the following formula:

balance time duration=actual charging electric quantity/unit balance electric quantity.

Through the above formula, the balance time duration may be acquired accurately and efficiently, and the efficiency of acquiring the balance time duration is improved.

Optionally, the step that the cell balance control circuit matched with the cell is controlled to perform electric quantity adjustment on the cell within the balance time duration includes the following acts.

At S1, the cell balance control circuit matched with the cell is controlled to stop the, electric quantity adjustment on the cell under a condition in which an end moment of the balance time duration is reached and the multi-cell battery is balanced.

At S2, updated actual charging electric quantity corresponding to the cell is acquired under a condition in which the end moment of the balance time duration is reached while the multi-cell battery is not balanced; an updated balance time duration is determined based on the updated actual charging electric quantity; and the cell balance control circuit matched with the cell is controlled to perform the electric quantity adjustment, on the cell within the updated balance time duration.

For instance, the above is described continuously with reference to the above condition in which the multi-cell battery includes three cells. In a case where the multi-cell battery still is not balanced after the cell balance control circuits are used to balance the cell 1, the cell 2 and the cell 3 respectively within the balance time duration, updated actual charging electric quantities need to be acquired; and then, balance time durations are determined according to new actual charging electric quantities and the cell 1, the cell 2 and the cell 3 are balanced In a case where the multi-cell battery is up to a balance state prior to the balance time duration in the process of balancing the cell 1, the cell 2 and the cell 3 with the cell balance control circuits, the balance on the multi-cell battery is stopped. In this way, the balance on the multi-cell battery may be stopped timely.

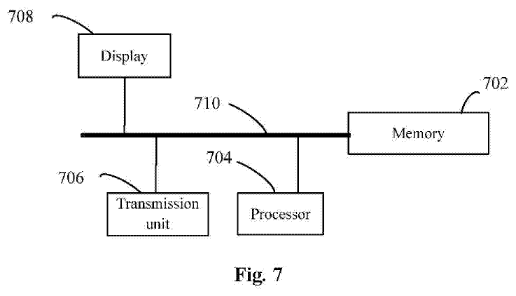

According to a still another aspect of the embodiments of the disclosure, as shown in FIG. 7, there is, further provided an electric vehicle for implementing the above battery charging control method, which, for each cell in at least one cell of a multi-cell battery, includes a processor 704 and the memory 702.

(1) The processor 704 is configured to execute a computer executable instruction.

(2) The memory 702 is configured to store the computer executable instruction; and the computer executable instruction, when being executed by the processor, enables the electric vehicle to execute the following steps.

At S1, after the multi-cell battery enters a charging stable state, actual charging electric quantity required for charging the cell to a target voltage is acquired.

At S2, a balance time duration for the cell is determined based on the actual charging electric quantity corresponding to the cell, wherein the balance time duration is a time duration required for a cell balance control circuit matched with the cell to control the cell.

At S3, the cell balance control circuit matched with the cell is controlled to perform electric quantity adjustment on the cell within the balance time duration.

Optionally, the electric vehicle may further include but not limited to a transmission unit 706, a display unit 708 and a connection bus 710.

(3) The transmission unit 706 is configured to receive or send data via a network.

(4) The display unit 708 is configured to display a balance state of the multi-cell battery.

(5) The connection bus 710 is configured to connect each modular component in the battery charging control apparatus.

In this embodiment, since the actual charging electric quantity when the each cell is charged to the target voltage is acquired, the electric quantity adjustment may be performed on the cell according to the balance time duration acquired by the actual charging electric quantity, and the purpose of adjusting the each cell accurately is achieved. Furthermore, the performance of the multi-cell battery is improved, so that the performance of the electric vehicle is improved.

The serial numbers of the embodiments of the disclosure are only used for descriptions, and do not represent the advantages or disadvantages of the embodiments.

If being implemented in a form of software function unit and sold or used as an independent product, the integrated unit in the embodiments may also be stored in a computer-readable storage medium. Based on such an understanding, the essence of the technical solutions of the disclosure or parts making constructions to the conventional art may be embodied in a form of a software product. The computer software product is stored in a storage medium, including a plurality of instructions used to enable one or more terminal devices (which may be a PC computer, a server or a network device, etc.) to execute the method in each embodiment of the disclosure.

In the above embodiments of the disclosure, descriptions of each embodiment are emphasized respectively, and parts which are not elaborated in detail in a certain embodiment may refer to relevant descriptions of other embodiments.

In some embodiments provided by the disclosure, it will be appreciated that the disclosed client may be implemented in other modes, wherein the apparatus embodiment described above is only schematic. For example, division of the units may be division of logical functions, and there may be additional division modes during actual implementation. For example, a plurality of units or components may be combined or integrated to another system, or some features may be omitted or may be not executed. In addition, displayed or discussed mutual coupling or direct coupling or communication connection may be performed via some interfaces, and indirect coupling or communication connection between units or modules may be in an electrical form or other forms.

The units that are described as separate components may be or may not be physically separated, and the components displayed as units may be or may not be physical units. That is, the units or components may be located at one place or scattered on several network units. Some or all of the units may be selected according to actual needs to implement the solutions in the embodiments of the disclosure.

In addition, all function units in each embodiment of the disclosure may be integrated into a processing unit, or exist as independent physical units, or two or more units may be integrated into one unit. The integrated units may be implemented by using hardware, or by using the form of software function units.

The above are only preferred implementation modes of the disclosure. It should be pointed out that those of ordinary skill in the art may also make some improvements and modifications without departing from the principle of the disclosure. These improvements and modifications should fall within the scope of protection of the disclosure.

What is claimed is:

1. A battery charging control method, for each cell in at least one cell of a multi-cell battery, comprising:
after the multi-cell battery enters a charging stable state, acquiring actual charging electric quantity required for charging the cell to a target voltage;
determining a balance time duration for the cell based on the actual charging electric quantity corresponding to the cell, wherein the balance time duration is a time duration required for a cell balance control circuit matched with the cell to control the cell; and
controlling, the cell balance control circuit matched with the cell to perform electric quantity adjustment on the cell within the balance time duration.

2. The method as claimed in claim 1, wherein before acquiring actual charging electric quantity required for charging the cell to a target voltage, the method further comprises:
acquiring cell stabilized voltages that a plurality of cells comprised in'the multi-cell battery reaches respectively when entering the charging stable state; and
determining the target voltage according to the cell stabilized, voltages.

3. The method as claimed in claim 1, before acquiring actual charging electric quantity required for charging the cell to a target voltage, further comprising:
acquiring accumulated charging electric quantity since the multi-cell battery enters a charging state; and
determining that the multi-cell battery enters the charging stable state under a condition in which the accumulated charging electric quantity reaches a first threshold.

4. The method as claimed in claim 3, after acquiring accumulated charging electric quantity since the multi-cell battery enters a charging state, further comprising:
clearing the accumulated charging electric quantity under a condition in which the accumulated charging electric quantity does not reach the first threshold and the charging is terminated.

5. The method as claimed in claim 1, wherein acquiring actual charging electric quantity required for charging the cell to a target voltage comprises:
acquiring a cell temperature in an environment where the cell is located at present; and
performing temperature compensation on the actual charging electric quantity corresponding to the cell according to a temperature curve, wherein under a condition in which the cell temperature in the environment where the cell is located at present is greater than a target temperature, the actual charging electric quantity is turned down according to a first proportion indicated by the temperature curve; and under a condition in which the cell temperature in the environment where the cell is located at present is smaller than the target temperature, the actual charging electric quantity is turned up according to a second proportion indicated by the temperature curve.

6. The method as claimed in claim 1, wherein determining a balance time duration for the cell based on the actual charging electric quantity corresponding to the cell comprises:
acquiring unit balance electric quantity configured to the cell balance control circuit matched with the cell; and
acquiring a ratio of the actual charging electric quantity to the unit balance electric quantity and setting the balance time duration corresponding to the cell equal to the ratio.

7. The method as claimed in claim 1, wherein controlling the cell balance control circuit matched with the cell to perform electric quantity adjustment on the cell within the balance time duration comprises:
controlling the cell balance control circuit matched with the cell to stop the electric quantity adjustment on the cell under a condition in which an end moment of the balance time duration is reached and the multi-cell battery is balanced;
acquiring updated actual charging electric quantity corresponding to the cell under a condition in which the end moment of the balance time duration is reached while the multi-cell battery is not balanced; determining an updated balance time duration based on the updated actual charging electric quantity; and controlling the cell balance control circuit matched with the cell to perform the electric quantity adjustment on the cell within the updated balance time duration.

8. A battery charging control apparatus, for each cell in at least one cell of a multi-cell battery, comprising:
a processor, configured to execute a computer executable instruction; and
a memory, configured to store the computer executable instruction, and the computer executable instruction, when being executed by the processor, enabling the apparatus to execute the following steps:
after a multi-cell battery enters a charging stable state, acquiring actual charging electric quantity required for charging the cell to a target voltage;
determining a balance time duration for the cell based on the actual charging electric quantity corresponding to the cell, wherein the balance time duration is a time duration required for a cell balance control circuit matched with the cell to control the cell; and
controlling the cell balance control circuit matched with the cell to perform electric quantity adjustment on the cell within the balance time duration.

9. The apparatus as claimed in claim 8, wherein before acquiring actual charging electric quantity required for charging the cell to a target voltage, the method further comprises:
acquiring cell stabilized voltages that a plurality of cells comprised in the multi-cell battery reaches respectively when entering the charging stable state; and
determining the target voltage according to the cell stabilized voltages.

10. The apparatus as claimed in claim 8, before acquiring actual charging electric quantity required for charging the cell to a target voltage, further comprising:
acquiring accumulated charging electric quantity since the multi-cell battery enters a charging state; and
determining that the multi-cell battery enters the charging stable state under a condition in which the accumulated charging electric quantity reaches a first threshold.

11. The apparatus as claimed in claim 10, after acquiring accumulated charging electric quantity since the multi-cell battery enters a charging state, further comprising:
clearing the accumulated charging electric quantity under a condition in which the accumulated charging electric quantity does not reach the first threshold and the charging is terminated.

12. The apparatus as claimed in claim 8, wherein acquiring actual charging electric quantity required for charging the cell to a target voltage comprises:
acquiring a cell temperature in an environment where the cell is located at present; and
performing temperature compensation on the actual charging electric quantity corresponding to the cell according to a temperature curve, wherein under a condition in which the cell temperature in the environment where the cell is located at present is greater than a target temperature, the actual charging electric quantity is turned down according to a first proportion indicated by the temperature curve; and under a condition in which the cell temperature in the environment where the cell is located at present is smaller than the target temperature, the actual charging electric quantity is turned up according to a second proportion indicated by the temperature curve.

13. The apparatus as claimed in claim 8, wherein determining a balance time duration for the cell based on the actual charging electric quantity corresponding to the cell comprises:
acquiring unit balance electric quantity configured to the cell balance control circuit matched with the cell; and
acquiring a ratio of the actual charging electric quantity to the unit balance electric quantity and setting the balance time duration corresponding to the cell equal to the ratio.

14. The apparatus as claimed in claim 8, wherein controlling the cell balance control circuit matched with the cell to perform electric quantity adjustment on the cell within the balance time duration comprises:
controlling the cell balance control circuit matched with the cell to stop the electric quantity adjustment on the cell under a condition in which an end moment of the balance time duration is reached and the multi-cell battery is balanced;
acquiring updated actual charging electric quantity corresponding to the cell under a condition in which the end moment of the balance time duration is reached while the multi-cell battery is not balanced; determining an updated balance time duration based on the updated actual charging electric quantity; and controlling the cell balance control circuit matched with the cell to perform the electric quantity adjustment on the cell within the updated balance time duration.

15. An electric vehicle, for each cell in at least one cell of a multi-cell battery, comprising:
a processor, configured to execute a computer executable instruction; and
a memory, configured to store the computer executable instruction, and the computer executable instruction, when being executed by the processor, enabling the apparatus to execute the following steps:
after a multi-cell battery enters a charging stable state, acquiring actual charging electric quantity required for charging the cell to a target voltage;
determining a balance time duration for the cell based on the actual charging electric quantity corresponding to the cell, wherein the balance time duration is a time duration required for a cell balance control circuit matched with the cell to control the cell; and
controlling the cell balance control circuit matched with the cell to perform electric quantity adjustment on the cell within the balance time duration.
